(19) United States
(12) Patent Application Publication
(10) Pub. No.: US 2015/0216331 A1
(43) Pub. Date: Aug. 6, 2015

(54) Magnetically Mounted Shower Mirror

(71) Applicant: Fabian Sanchez, New York, NY (US)

(72) Inventor: Fabian Sanchez, New York, NY (US)

(21) Appl. No.: 14/172,788

(22) Filed: Feb. 4, 2014

(51) Int. Cl. A47G 1/17; A45D 42/16; F21V 23/04; A45D 42/10; F21V 23/00

(52) U.S. Cl. CPC A47G 1/17; A45D 42/10; F21V 23/004; F21V 23/04; F21V 23/001; A45D 42/16; F21Y 2101/02

(57) ABSTRACT

A two-piece magnetically mounted shower mirror of the present invention comprises a mirror housing apparatus with magnets and lighting capability, and a magnetic mount with magnets aligned and corresponding to the magnets on the mirror. The present invention is a significant improvement to current suction cup mounted shower mirrors. The magnetic mounts allow a user to reliably mount the present invention to flat surfaces such as shower doors as well as non-flat surfaces such as shower curtains while providing the opportunity to move the mirror as needed.

### REFERENCE TO RELATED APPLICATIONS

This patent application claims the benefit of U.S. Provisional Application No. 61/760,542 filed on Feb. 4, 2013, the disclosure of which is incorporated herein by reference in its entirety.

### BACKGROUND OF THE INVENTION

1. Field of the Invention

The present invention relates generally to shower accessories. More specifically, the present invention is a two-piece magnetically mounted shower mirror with integrated lighting capability and can be attached to shower curtain or shower door.

2. Description of Related Art

Shower mirrors have many uses that enhance user convenience. Mirrors are necessary during shaving and other similar personal grooming practices. These mirrors are typically mounted somewhere within a shower area such as on the flat wall surfaces or on the showerhead. Mirror attachment on flat wall surfaces generally encompasses the use of one or more suction cup mounts to hold the mirrors against the surfaces.

Alternative methods of attachment include the use of looped string or cord to drape a mirror over a showerhead. The use of suction cups as mirror mounts presents a number of problems. Suction cup quality decreases significantly after extended use, rendering the suction cups unreliable. The suction cup material is permeable as well, retaining moisture that makes the suction cups discolored and hard to clean over time. Degradation of the suction cup material over time can potentially cause the suction cups to become so unreliable that the mirrors fall from their mounted positions. Shattered mirrors caused by unsafe mounts present a significant safety hazard for users. In addition to poor mount quality and potential safety issues, the use of traditional mounts such as suction cups generally require flat surfaces. These types of mounts cannot be used on surfaces such as shower curtains. The present invention seeks to address the previously discussed issues and provide a shower mirror with a more effective and reliable mounting mechanism. In addition, the present invention seeks to improve and enhance user convenience when using the shower mirror.

### SUMMARY OF THE INVENTION

The present invention is a magnetically mounted shower mirror with an integrated lighting system. In its preferred embodiment, the present invention comprises a mirror housing apparatus and a magnetic mount. The mirror housing apparatus features a mirror and a plurality of magnets on the exterior or interior surfaces of the apparatus. The mirror housing apparatus encases a plurality of light emitting diodes (LED), a circuit board, and a battery. The LEDs are activated and deactivated by a switch present on the exterior surface of the mirror housing apparatus. Additionally, the LEDs may be automatically turned off after a specified amount of time. A small hinged or rubber door along the exterior surface of the mirror housing apparatus allows a user to replace the battery. The mirror housing apparatus is mounted to one side of a mounting surface such as a shower curtain or shower door. The magnetic mount is attached to the opposite side of the mounting surface. The magnets of the magnetic housing apparatus and the magnetic mount are aligned. The magnetic force between the magnets of the magnetic housing apparatus and the magnetic mount serves to hold the two components in place on the mounting surface and prevents the components from slipping or falling off of the surface.

In another preferred embodiment, a mirror with magnets attached to its back replaces the mirror housing apparatus. Like the mirror housing apparatus, the mirror with the magnets is also mounted to one side of a mounting surface. The magnetic mount is attached to the opposite side of the mounting surface. The magnets of the magnetic housing apparatus and the magnetic mount are aligned. The magnetic force between the magnets of the magnetic housing apparatus and the magnetic mount serves to hold the two components in place on the mounting surface and prevents the components from slipping or falling off of the surface.

Such device can be structured with or without the casing whereas said features of attachment would still apply with the use of a traditional magnet to metal backing design.

The magnetically mounted shower mirror of the present invention is a significant improvement to current suction cup mounted shower mirrors. The magnetic mounts allow a user to reliably mount the present invention to flat surfaces such as shower doors as well as non-flat surfaces such as shower curtains while providing the opportunity to move the mirror as needed. Unlike suction cups, magnetic mounts do not become discolored and do not require a large amount of cleaning due to prolonged water exposure. The magnetic mounts of the present invention are much less likely to degrade due to use over an extended period of time. This lowers the chance of a potential safety hazard caused by the mirror falling and shattering. While the magnetic mount allows the present invention to be utilized on non-metallic surfaces, the magnetic housing apparatus may also be used separately, independent of the magnetic mount. As such, the magnetic housing apparatus may be mounted on virtually any metallic surface, further increasing the versatility of the present invention.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is an isometric view of the mirror housing apparatus of the present invention showing the mirror, the switch and a small door to the battery compartment located on the first side of the mirror housing apparatus.

FIG. 2 is an isometric exploded view of the mirror housing apparatus of the present invention showing the magnet and the interior chamber of the mirror housing apparatus where LEDs located around the circumference of the interior and the circuit board and the battery compartment.

FIG. 3 is a front view of the mirror housing apparatus of the present invention showing the mirror, switch, and small door to the battery compartment located on the first side of the mirror housing apparatus.

FIG. 4 is a back view of the mirror housing apparatus of the present invention.

FIG. 5 is an isometric exploded view of the magnetic mount of the present invention showing the magnet located on one side of the magnetic mount.

FIG. 6 is an isometric exploded view of the present invention detailing assembly of the mirror housing apparatus, and the magnetic mount on the left side showing that the magnets on the mirror housing apparatus and the magnetic mount are aligned (other elements are not shown in this figure); and the mirror housing apparatus, adhesive pads, and the magnetic mount on the right side.

FIG. 7 is an isometric view of the present invention detailing assembly of the mirror housing apparatus, and the magnetic mount.

FIG. 8 is a front view of the present invention detailing attachment of the mirror housing apparatus, and the magnetic mount to a shower curtain.

FIG. 9 is an isometric view of the present invention detailing attachment of the mirror housing apparatus, and the magnetic mount to a shower curtain.

FIG. 10 is an isometric view of another embodiment of the present invention where a mirror with magnets replacing the mirror housing apparatus showing that the mirror has magnets on its back.

### DESCRIPTION OF THE PREFERRED EMBODIMENT

All illustrations of the drawings are for the purpose of describing selected versions of the present invention and are not intended to limit the scope of the present invention.

The present invention is a magnetically mounted shower mirror 100 with an integrated lighting system. In its preferred embodiment, the present invention comprises a mirror housing apparatus, a magnetic mount, and two adhesive pads. The two components both feature one or more magnets for the purpose of mounting to a surface. The mirror housing apparatus is magnetically attached to one side of a mounting surface such as a shower curtain or a shower door and the magnetic mount is attached to the other side of the surface. The magnetic force between the magnets of the mirror housing apparatus and the magnetic mount serves to draw the two components together and hold the components in place through the mounting surface.

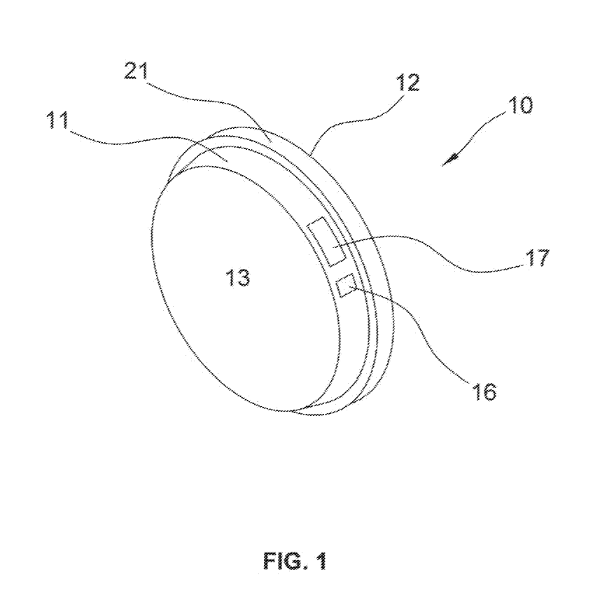

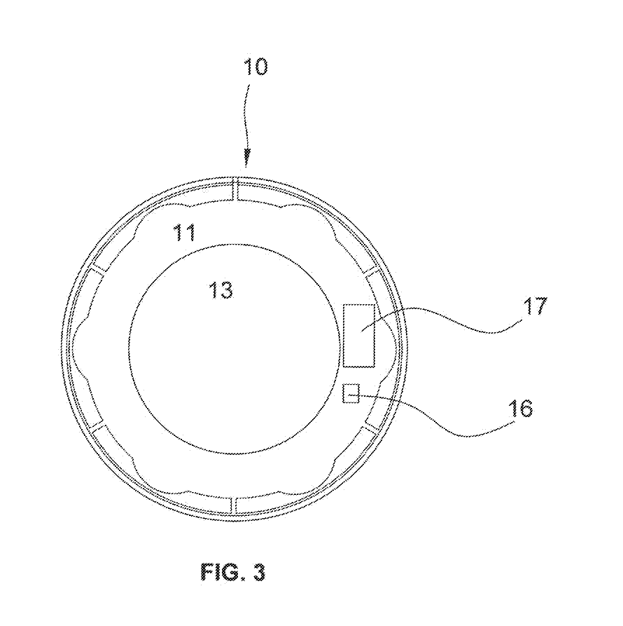

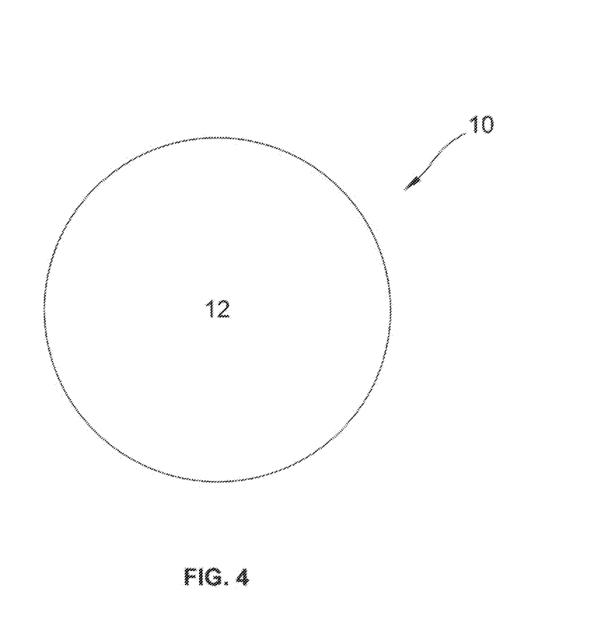

Referring to FIG. 1-4, in the preferred embodiment of the present invention, a mirror housing apparatus 10 comprises a circular extrusion of material with a first side 11 and a second side 12. The surface of the first side 11 of the mirror housing apparatus 10 comprises a mirror 13. The second side 12 of the mirror housing apparatus features one or more magnets 14. The mirror housing apparatus 10 further has one side 21 (for a circular shape) or more sides (for a rectangular shape) perpendicularly connected to the first 11 and second sides 12 forming an encasement 23 having an empty interior chamber 15. The encasement may be made from extrusion of materials.

On the exterior of the mirror housing apparatus 10 is located a switch 16. The switch is utilized to activate electronic components housed within the mirror housing apparatus. A small door 17 to the battery compartment is located adjacent to the switch for use in battery replacement. The material of the mirror housing apparatus is translucent to allow for the passage of light around the circumference of the mirror housing apparatus. In alternative embodiments of the present invention, the mirror housing apparatus may be of a non-circular shape.

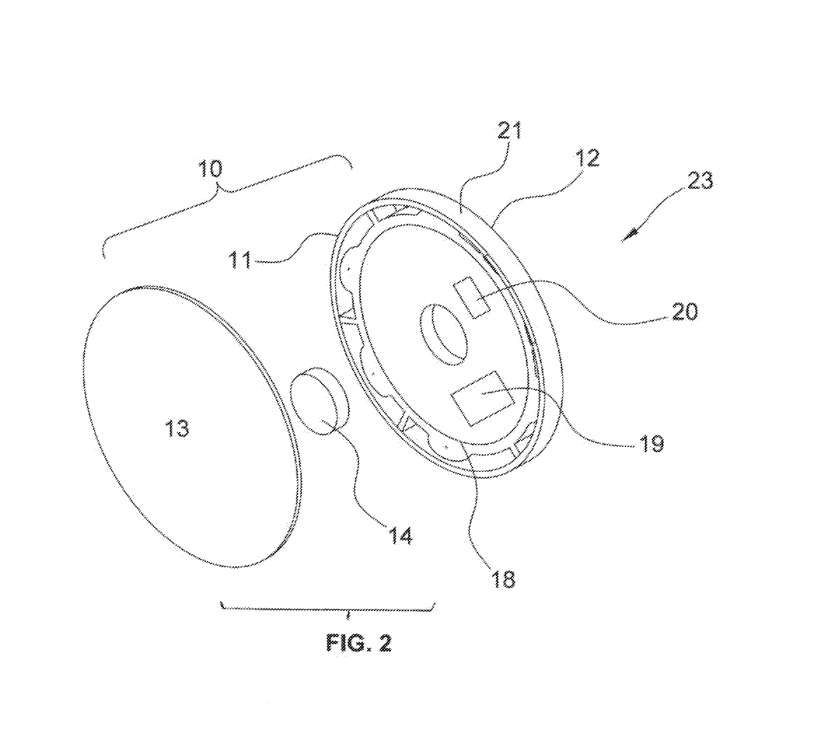

With reference to FIG. 2, the electronic components of the present invention are housed within the interior chamber 15 of the mirror housing apparatus 10. The mirror housing apparatus prevents the internal electronic components from coming into contact with water when the present invention is in use. In the preferred embodiment of the present invention, the mirror housing apparatus 10 encases a plurality of light emitting diodes (LED) 18, a circuit board 19, and a battery. A plurality of LEDs is arranged in a circular layout around the circumference of the interior of the mirror housing apparatus. The present invention is not limited with respect to the number of LEDs encased within the mirror housing apparatus. The LEDs are electrically connected to and regulated by a circuit board contained within the mirror housing apparatus as well. The LEDs are activated and deactivated by means of the switch 16 located on the exterior of the mirror housing apparatus. A user may turn the LEDs on or off by engaging the switch. However, the LEDs may automatically turn off after a specific amount of time as well. The LEDs and circuit board of the mirror housing apparatus draw power from a replaceable battery. The battery is housed within a battery compartment 20 located within the mirror housing apparatus and directly adjacent to the hinged door 17 on the exterior of the mirror housing apparatus. Closing the hinged door 17 seals the battery compartment from the exterior environment.

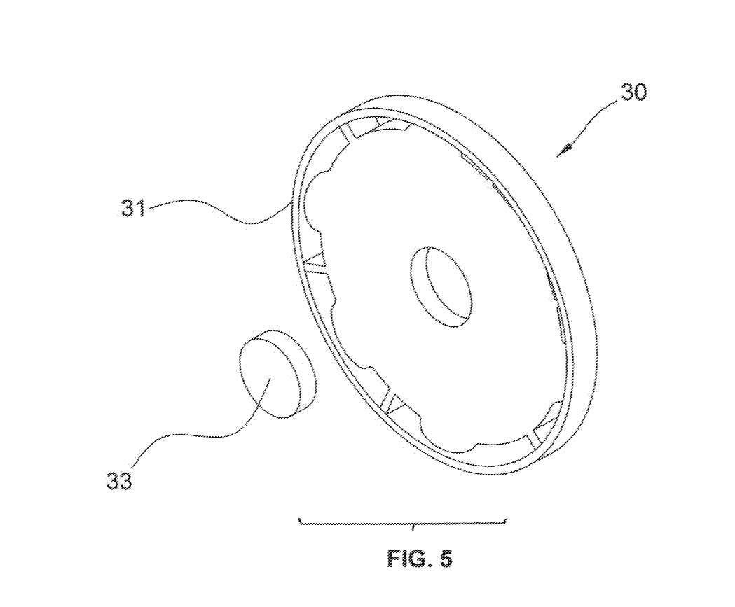

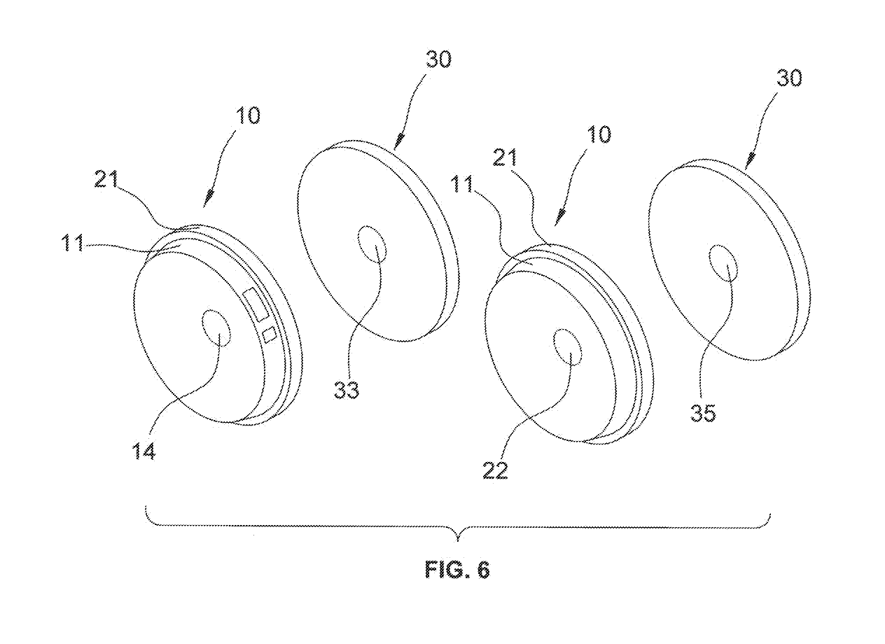

With respect to FIG. 5, in the preferred embodiment of the present invention, a magnetic mount 30 comprises a thin circular extrusion of material. The diameter of the circular magnetic mount is approximately the same as that of the mirror housing apparatus. One side 31 of the circular magnetic mount 30 features one or more magnets 33. As shown in FIG. 6, the magnets 33 are arranged in a layout that matches the arrangement of magnets 14 present on the mirror housing apparatus. As with the mirror housing apparatus, in alternative embodiments of the present invention, the magnetic mount may be of a noncircular shape.

Referring to FIG. 6, the magnets 14, 33 of the mirror housing apparatus and the magnetic mount 30 are aligned in order to secure the two components through a mounting surface as shown on the left side of the figure. An adhesive pad 22, 35 is applied to the magnets of both the magnetic housing apparatus and the magnetic mount as shown on the right side of the figure.

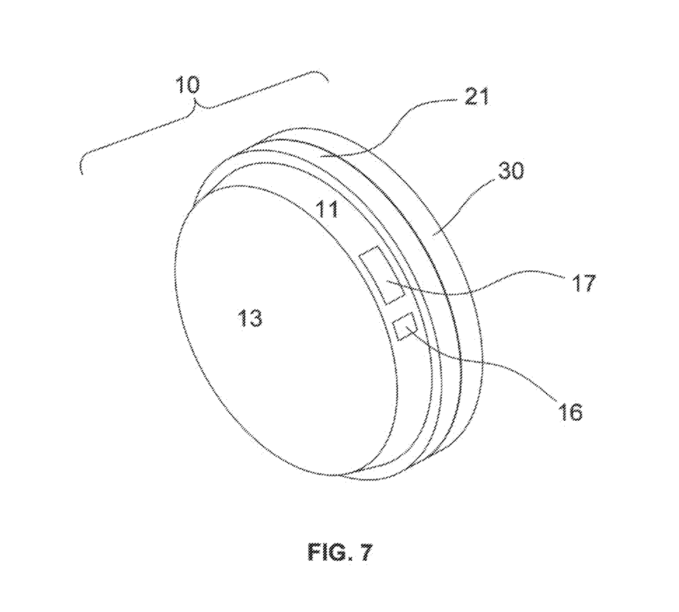

FIG. 7 is an isometric view of the present invention detailing assembly of the mirror housing apparatus, and the magnetic mount.

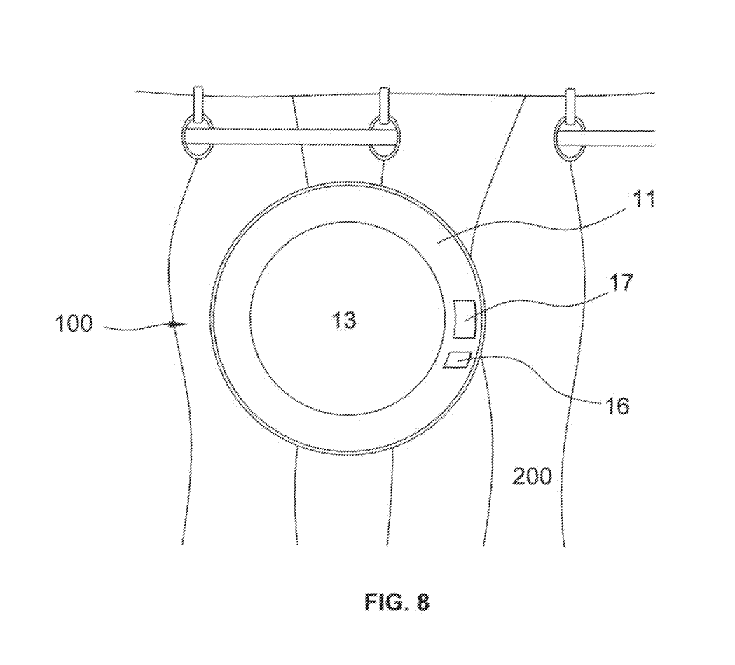

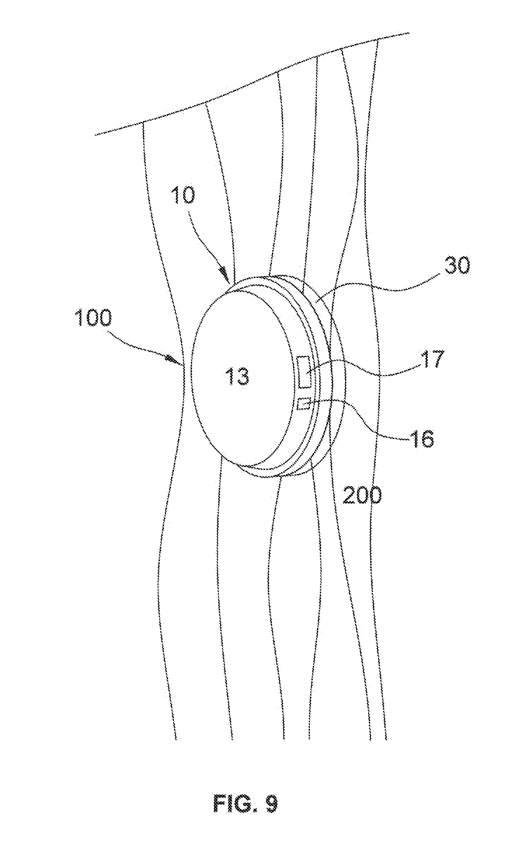

As shown in FIGS. 8-9, the mirror housing apparatus 10 is attached to one side of a mounting surface such as a shower curtain 200 or a shower door while the magnetic mount 30 is attached to the other side. The two components 10, 30 are held in place through the mounting surface 200 as the corresponding magnets of the two components are aligned. The magnetic force between the magnets 14, 33 of the mirror mounting apparatus and the magnetic mount serves to draw the two components 10, 30 together and hold the components in place on the mounting surface. The magnetic attachment is secured such that the mirror mounting apparatus and the magnetic mound do not slip or fall off of the mounting surface. The two adhesive pads prevent the components from slipping on the mounting surface.

The present invention provides users with a shower mirror to assist during shaving and other similar personal grooming practices. Additionally, the present invention provides users with a supplementary light source in poorly lit shower areas.

The LEDs within the mirror housing apparatus are visible through the translucent material of the mirror housing apparatus.

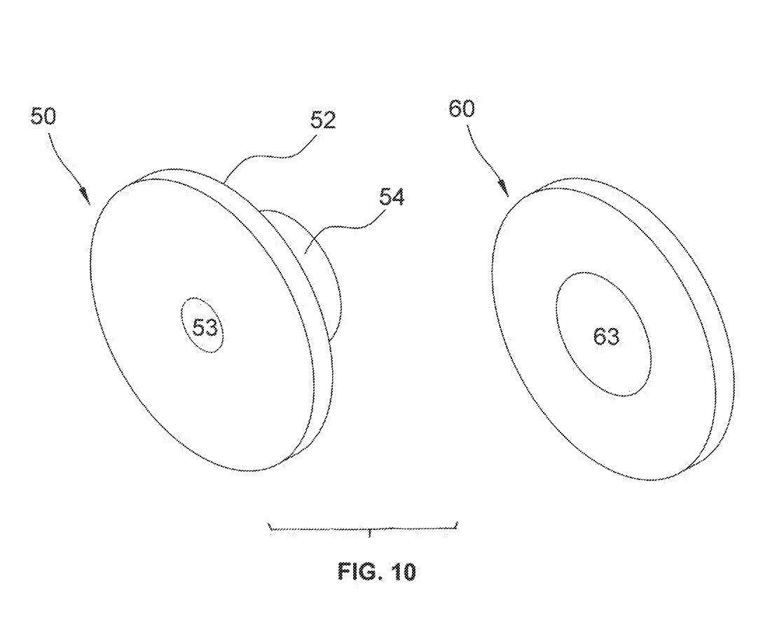

FIG. 10 is an isometric view of another embodiment of the present invention where a mirror with magnets 50 replaces the mirror housing apparatus 10. The mirror 53 has magnets 54 attached to its back 52 by any fastening means known in the art, including glue. The magnetic mount 60 has magnets 63 aligned to and corresponding to the magnets 54 and arranged in a layout that matches the arrangement of the magnets 54 present on the back of the mirror 53.

In use, the mirror with magnets 50 is attached to one side of a mounting surface such as a shower curtain 200 or shower door while the magnetic mount 60 is attached to the other side. The two components 50, 60 are held in place through the mounting surface as the corresponding magnets of the two components are aligned. The magnetic force between the magnets 54, 63 of the mirror with magnets 50 and the magnetic mount 60 serves to draw the two components 50, 60 together, and hold the components in place on the mounting surface 200. The magnetic attachment is secured such that the mirror with magnets 50 and the magnetic mount 60 do not slip or fall off of the mounting surface. The two adhesive pads prevent the components from slipping on the mounting surface.

Although the figures only show one magnet in the mirror housing apparatus 10 or mirror with magnets 50, and magnetic mount 30, 60, the invention may comprise more magnets in said components 10, 50, 30, 60.

The magnetic attachment mechanism of the present invention is superior to the suction cup attachment method primarily utilized by conventional shower mirrors as the magnetic force connection is far more reliable than the suction cup attachment method.

Magnets do not become discolored and do not require cleaning as suction cups do after prolonged use and exposure to water. Additionally, the magnets are less likely to degrade and fail over time, preventing the safety hazard of mounted mirrors falling and shattering.

The magnetic attachment mechanism also allows a user to easily relocate the mounted mirror as needed. Finally, as shown in FIG. 8-9, the magnetic attachment method allows the shower mirror to be mounted to non-flat surfaces such as shower curtains in addition to flat surfaces such as shower doors.

Although the present invention has been explained in relation to its preferred embodiment, it is understood that many other possible modifications and variations can be made without departing from the spirit and scope of the present invention.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A two-piece magnetic mounted mirror comprising:
a mirror housing apparatus comprising:
a pair of parallel sides including a first side and a second side;
a mirror attached to the first side; and
one or more magnets attached to the second side; and
a magnetic mount having one or more magnets aligned with and corresponding to the magnets of the mirror housing apparatus;
wherein the mirror housing apparatus is mounted to one side of a mounting surface and the magnetic mount is attached to the opposite side of the non-metallic mounting surface so that a magnetic force between the magnets of the mirror housing apparatus and the magnets of the magnetic mount draws them together and holds them in place through the mounting surface.

2. The two-piece magnetic mounted mirror of claim 1, wherein the magnets of the magnetic mount are arranged in a layout that matches an arrangement of the magnets present on the mirror housing apparatus.

3. The two-piece magnetic mounted mirror of claim 2, wherein the mirror housing apparatus further comprising:
one or more sides perpendicularly connected to the first and second sides forming an encasement having an empty interior chamber;
a plurality of light emitting diodes (LEDs) arranged in a layout around a perimeter of the interior chamber of the mirror housing apparatus;
a circuit board contained within the interior chamber of the mirror housing apparatus to regulate the LEDs;
a battery compartment located within the mirror housing apparatus having a small hinged door to seal the compartment;
one or more batteries housed within the battery compartment to supply power to the LEDs and circuit board; and
a switch located on an exterior of the mirror housing apparatus to activate and deactivate the LEDs; and
electric wires to connect the LEDs to the circuit board, switch, and batteries.

4. The two-piece magnetic mounted mirror of claim 3, where the mirror housing apparatus is made of translucent material to allow for the passage of light around the perimeter of the mirror housing apparatus.

5. The two-piece magnetic mounted mirror of claim 4, wherein the mirror housing apparatus is circular in shaped, the plurality of LEDs is arranged in a circular layout around the circumference of the interior chamber of the mirror housing apparatus.

6. The two-piece magnetic mounted mirror of claim 5, wherein the magnetic mount is circular in shape and has approximately the same diameter as that of the mirror housing apparatus.

7. The two-piece magnetic mounted mirror of claim 4, wherein the mirror housing apparatus and magnetic mount are noncircular shaped.

8. The two-piece magnetic mounted mirror of claim 4, wherein the magnetic mount is smaller than the mirror housing apparatus.

9. The two-piece magnetic mounted mirror of claim 4, wherein the LEDs may be automatically turned off after a specified amount of time.

10. The two-piece magnetic mounted mirror of claim 1, wherein the magnetic housing apparatus is used separately, independent of the magnetic mount on virtually any metallic surface, further increasing the versatility.

11. The two-piece magnetic mounted mirror of claim 1, further comprising adhesive pads applied to the magnets on the mirror housing apparatus and the magnetic mount to prevent the mirror housing apparatus and magnetic mount from slipping on the mounting surface.

12. The two-piece magnetic mounted mirror of claim 3, wherein the encasement of the mirror housing apparatus is made from extrusion of materials.

13. The two-piece magnetic mounted mirror of claim 1, wherein the magnetic mount comprises a thin extrusion of material.

14. A two-piece magnetic mounted mirror, comprising:
a mirror with magnets having one or more magnets on its back; and
a magnetic mount having one or more magnets aligned with and corresponding to the magnets on the back of the mirror;
wherein the mirror with magnets is mounted to one side of a mounting surface and the magnetic mount is attached to the opposite side of the mounting surface such that a magnetic force between the magnets of the mirror and the magnets of the magnetic mount draws them together and holds them in place through the mounting surface.

15. The two-piece magnetic mounted mirror of claim 14, wherein the magnets of the magnetic mount are arranged in a layout that matches an arrangement of the magnets present on the back of the mirror.

16. The two-piece magnetic mounted mirror of claim 15, wherein the mirror with magnets and magnetic mount are circular in shape and have approximately same diameter.

17. The two-piece magnetic mounted mirror of claim 15, wherein the mirror with magnets and magnetic mount are of noncircular shape and are same in width and length.

18. The two-piece magnetic mounted mirror of claim 15, wherein the mirror with magnets and magnetic mount are of different shapes and have different widths and lengths.

19. The two-piece magnetic mounted mirror of claim 16, further comprising adhesive pads applied to the magnets on the mirror and the magnetic mount to prevent the mirror and magnetic mount from slipping on the mounting surface.

20. The two-piece magnetic mounted mirror of claim 16, wherein the magnets are glued to the back of the mirror.
